(19) United States
(12) Patent Application Publication
(10) Pub. No.: US 2007/0081098 A1
(43) Pub. Date: Apr. 12, 2007

(54) Digital TV and control method thereof

(75) Inventors: Jin-hee Sohn, Seoul (KR); Young-sil Lim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/544,704

(22) Filed: Oct. 10, 2006

(30) Foreign Application Priority Data
Oct. 7, 2005 (KR) 10-2005-0094553

(51) Int. Cl. H04N 11/00

(52) U.S. Cl. 348/461

(57) ABSTRACT

A digital TV for receiving broadcasting signals containing time information for respective channels, the digital TV including a tuner for tuning the broadcasting signals corresponding to the respective channels; and a controller for reading the time information contained in the tuned broadcasting signals for the respective channels and detecting an erroneous channel that receives erroneous time information, based on a plurality of pieces of read time information. Thus, the present invention provides a digital TV which is capable of correcting erroneous time information received therein, and a control method thereof.

### CROSS-REFERENCE TO RELATED APPLICATIONS

This application claims the benefit under 35 U.S.C.§119 of Korean Patent Application No. 2005-0094553, filed on Oct. 7, 2005, the entire disclosure of which is hereby incorporated by reference.

### BACKGROUND OF THE INVENTION

1. Field of the Invention

Apparatuses and methods consistent with the present invention relate to a digital TV and control method thereof, and more particularly, to a digital TV for processing digital broadcasting signals containing real-time information, and control method thereof.

2. Description of the Related Art

In general, a digital TV compresses and transmits digital video signals, digital audio signals, and digital data signals containing PSIP (Program and System Information Protocol), EPG (Electronic Program Guide) and so on.

In addition, the digital data signal contains time information provided from a broadcasting station that supplies a broadcasting signal. This time information received through a relevant channel is automatically used to set the time in the digital TV if a user does not set the time in the digital TV manually.

In this case, the user may perform reservation of a particular program or an on/off operation of the digital TV based on the time information provided from the broadcasting station. Also, the above-mentioned EPG is data set based on the time information.

At the present time, many broadcasting stations may provide different or erroneous time information. If a broadcasting station provides erroneous time information to a digital TV, there may occur a problem in operation of the digital TV for the process of the reservation or time information and a problem in that a correct EPG may not be provided to the digital TV.

### SUMMARY OF THE INVENTION

Accordingly, it is an aspect of the present invention to provide a digital TV which is capable of correcting erroneous time information received therein, and a control method thereof.

The foregoing and/or other aspects of the present invention are achieved by providing a digital TV for receiving broadcasting signals containing time information for respective channels, comprising: a tuner for tuning the broadcasting signals corresponding to the respective channels; and a controller for reading the time information contained in the tuned broadcasting signals for the respective channels and detecting an erroneous channel that receives erroneous time information, based on a plurality of pieces of read time information.

According to au exemplary embodiment of the present invention, the controller makes a comparison between the plurality of pieces of read time information and determines that a channel that receives the erroneous time information having a difference from other time information, the difference falling outside a predetermined range, is the erroneous channel.

According to an exemplary embodiment of the present invention, the controller calculates an average of the time information read from channels other than the erroneous channel and stores the average of the time information.

According to an exemplary embodiment of the present invention, the digital TV further comprises a display on which the received broadcasting signals are displayed, wherein the controller displays the stored average of the time information on the display when a broadcasting signal is received from the erroneous channel.

The foregoing and/or other aspects of the present invention are achieved by providing a digital TV for receiving broadcasting signals containing time information for respective channels, comprising: a tuner for tuning the broadcasting signals corresponding to the respective channels; an erroneous channel detector for reading the time information contained in the tuned broadcasting signals for the respective channels, making a comparison between the plurality of pieces of read time information, and detecting an erroneous channel that receives erroneous time information having a difference from other time information, the difference falling outside a predetermined range; a display on which the received broadcasting signals are displayed; and a controller for calculating and storing an average of the time information read from channels other than the detected erroneous channel and displaying the stored average of the time information on the display when a broadcasting signal is received from the erroneous channel.

The foregoing and/or other aspects of the present invention are achieved by providing a control method of a digital TV for receiving broadcasting signals containing time information for respective channels, comprising: tuning the broadcasting signals corresponding to the respective channels; reading the time information contained in the tuned broadcasting signals for the respective channels; making a comparison between the plurality of pieces of read time information and detecting an erroneous channel that receives erroneous time information having a difference from other time information, the difference falling outside a predetermined range; calculating and storing an average of the time information read from channels other than the detected erroneous channel; and displaying the stored average of the time information when a broadcasting signal is received from the erroneous channel.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a control block diagram of a digital TV according to a first exemplary embodiment of the present invention;

FIG. 2 is a control block diagram of a digital TV according to a second exemplary embodiment of the present invention; and

FIG. 3 is a control flow chart illustrating a control method of the digital TV according to the second exemplary embodiment of the present invention.

### DETAILED DESCRIPTION OF THE EXEMPLARY EMBODIMENTS

Reference will now be made in detail to exemplary embodiments of the present invention, examples of which are illustrated in the accompanying drawings.

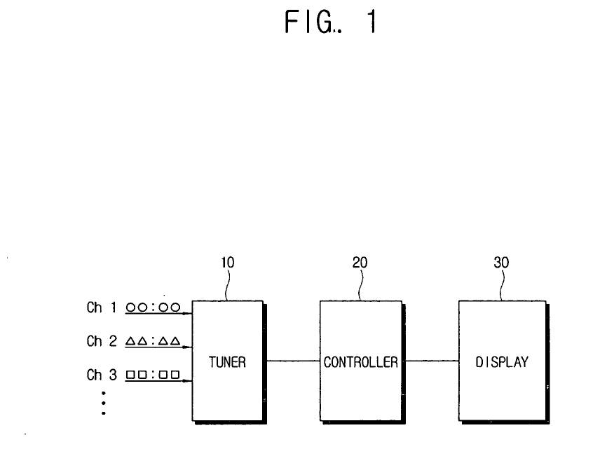

FIG. 1 is a control block diagram of a digital TV according to a first embodiment of the present invention. As shown in FIG. 1, a digital TV according to this embodiment includes a tuner 10, a controller 20 and a display 30.

The digital TV receives broadcasting signals of various frequency bands from a plurality of broadcasting signal sources, commonly, broadcasting stations.

The tuner 10 tunes broadcasting signals corresponding to all channels when the digital TV is powered on. In general, when the digital TV is powered on, only a broadcasting signal corresponding to a channel set before the digital TV is powered off, is tuned. However, the tuner 10 according to this embodiment of the present invention tunes broadcasting signals corresponding to all channels in order to read time information on all channels.

As shown in FIG. 1, a plurality of broadcasting signals received in the tuner 10 via respective channels contains respective time information, which may be equal to or different from one another. The time information generally includes date, hour and minute, and a user may be aware of present time indicated as 00:00 (hour:minute), 00 (month) 00 (day), 0000 (year) or 00:00 (hour:minute) through the time information. In an exemplary embodiment, the time information is the current time as transmitted by each of the plurality of channels.

The tuner 10 for tuning all channels may be separately provided or may be a sub-tuner provided in a digital TV which is capable of implementing PIP (picture in picture).

The display 30 displays a broadcasting signal corresponding to each channel, which is received via the tuner 10. Accordingly, the time information contained in the broadcasting signal is also displayed on the display 30.

The controller 20 reads the time information, which is contained in the plurality of broadcasting signals tuned through the tuner 10, for respective channels, and, based on the read time information, detects an erroneous channel that receives wrong time information. A method by which the controller 20 detects the erroneous channel may be implemented by various algorithms. For example, since the time information sent from a plurality of broadcasting stations may be nearly similar to one another, but not exactly equal to one another, a channel that receives time information having the greatest difference from other time information may be detected as an erroneous channel, or a channel that receives time information having the greatest deviation from an average of the received time information may be determined as an erroneous channel. As an example, the greatest difference from other received time information may be determined by summing the differences between one time information and other time information. A time information which the greatest sum would be considered as the time information having the greatest difference. Hereinafter, time information received via an erroneous channel is defined as erroneous time information.

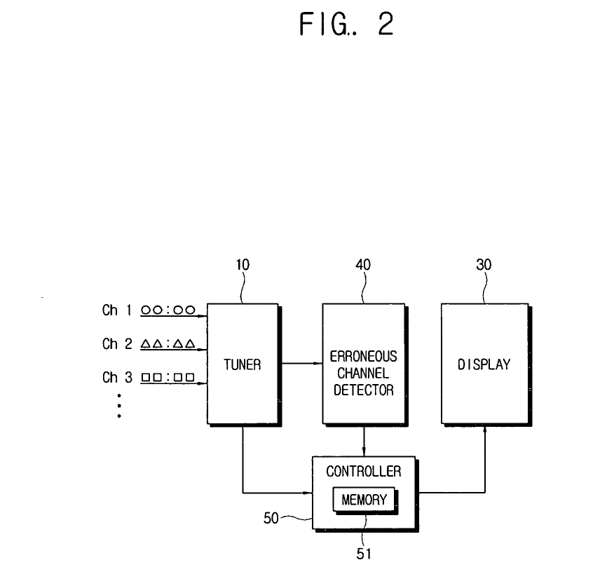

FIG. 2 is a control block diagram of a digital TV according to a second embodiment of the present invention. As shown in FIG. 2, the digital TV includes a tuner 10, an erroneous channel detector 40, a display 30 and a controller 50. The controller 50 contains a memory 51. The digital TV according to the second embodiment is different in the configuration of the controller of the first embodiment. That is, unlike the digital TV according to the first embodiment, the digital TV according to the second embodiment further includes the erroneous channel detector 40 and the memory 51. Since the tuner 10 and the display 30 have the same configuration and function as those in the first embodiment, detailed explanation thereof will be omitted for the purpose of brevity of explanation.

The erroneous channel detector 40 reads a plurality of pieces of time information contained in tuned broadcasting signals and makes a comparison between the plurality of pieces of read time information to determine whether or not differences therebetween fall outside a predetermined range. The predetermined range may be set by a user, or alternatively, may be automatically set in real time depending on differences between the plurality of time information detected by the erroneous channel detector 40. A channel that receives erroneous time information, which has a significantly greater difference from other time information, of the time information detected from the plurality of channels is determined to be an erroneous channel by the erroneous channel detector 40, and information on the erroneous channel is output to the controller 50.

The controller 50 stores the information on the erroneous channel provided from the erroneous channel detector 40 in the memory 51. In addition, the controller 50 calculates an average of time information read from channels other than the erroneous channel and stores the calculated average in the memory 51. According to such calculation of the controller, an average of broadcasting time received from broadcasting stations is stored in the memory 51. In other words, when a broadcasting signal is received in an erroneous channel, time set in the digital TV corresponds to an average of time information stored in the memory 51.

If the broadcasting signal is received in the erroneous channel, the controller 50 displays the average of time information stored in the memory 51, rather than the erroneous time information received, on the display 30. In addition, EPG data may be utilized based on the time information stored in the memory 51, and a user may perform an operation, such as a reservation of broadcasting programs, using the time information.

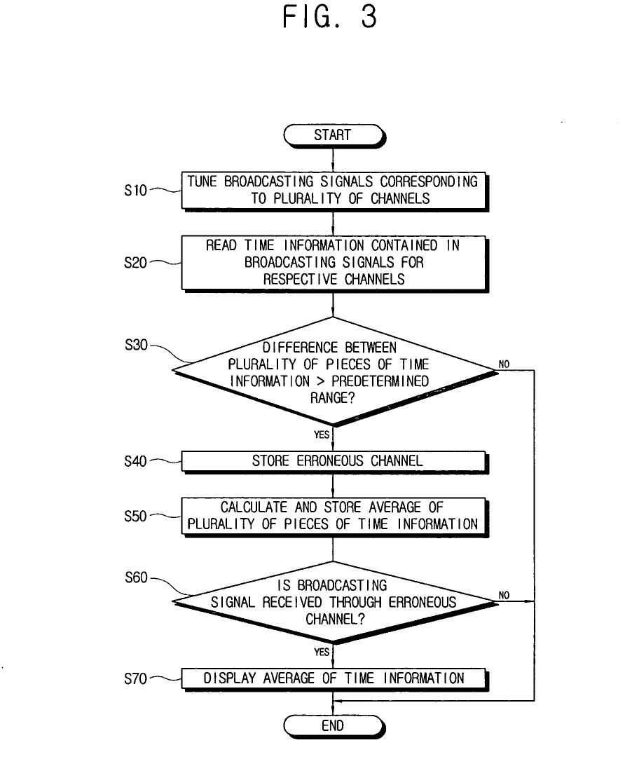

FIG. 3 is a control flow chart illustrating a control method of the digital TV according to the second embodiment of the present invention.

First, when the digital TV is powered on, the tuner 10 tunes broadcasting signals corresponding to a plurality of channels at operation S10. The erroneous channel detector 40 reads time information contained in the tuned broadcasting signals for respective channels at operation S20 and makes a comparison between a plurality of pieces of read time information to determine whether or not differences therebetween fall outside a predetermined range at operation S30. If the differences fall within the predetermined range, functions of the erroneous channel detector 40 and the controller 50 are stopped.

On the other hand, if the differences fall outside the predetermined range, the erroneous channel detector 40 determines that a channel that receives time information outside the predetermined range is an erroneous channel. This erroneous channel is stored in the memory 51 of the controller 50 at operation S40.

The controller 50 calculates an average of a plurality of pieces of time information, other than the erroneous time information corresponding to the erroneous channel, of time information of broadcasting signals received from the tuner 10 and stores the calculated average in the memory 51 at operation S50.

Then, when a broadcasting signal is received in the erroneous channel at operation S60, the controller 50 displays the average of time information stored in the memory 51, rather than time information of the broadcasting signal received in the erroneous channel, on the display 30 at operation S70. Thus, even when the broadcasting signal is received in the erroneous channel, since corrected time information is set in the digital TV and is displayed on the display 30, a user may properly use the digital TV, regardless of error of time information.

As apparent from the description, the present invention provides a digital TV which is capable of correcting erroneous time information received therein, and a control method thereof.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A digital TV comprising:
a tuner which tunes broadcasting signals corresponding to respective channels and receives the broadcasting signals including time information from the respective channels; and
a controller which reads the time information included in the tuned broadcasting signals for the respective channels and which detects an erroneous channel that receives erroneous time information, based on a plurality of pieces of read time information.

2. The digital TV according to claim 1, wherein the controller determines that one of the channels that receives the erroneous time information is the erroneous channel based on the plurality of pieces of read time information, the erroneous time information having a difference from the plurality of pieces of read time information that is greater than a predetermined range.

3. The digital TV according to claim 1, wherein the controller calculates an average of the time information read from channels other than the erroneous channel and stores the average of the time information.

4. The digital TV according to claim 3, further comprising a display on which the received broadcasting signals are displayed,
wherein the controller displays the stored average of the time information on the display when a broadcasting signal of the erroneous channel is received.

5. A digital TV comprising:
a tuner which tunes broadcasting signals corresponding to respective channels;
an erroneous channel detector which reads time information contained in the tuned broadcasting signals for the respective channels, makes a comparison between a plurality of pieces of read time information, and detects an erroneous channel that receives erroneous time information, the erroneous time information having a difference from other time information that is greater than a predetermined range;
a display on which the received broadcasting signals are displayed; and
a controller which calculates and stores an average of the time information read from channels other than the detected erroneous channel and displays the stored average of the time information on the display when a broadcasting signal of the erroneous channel is received.

6. A control method of a digital TV comprising:
receiving broadcasting signals including time information for corresponding channels;
tuning the broadcasting signals corresponding to the respective channels;
reading the time information included in the tuned broadcasting signals for the respective channels;
detecting an erroneous channel that receives erroneous time information, based on read time information, the erroneous time information having a difference from other time information that is greater than a predetermined range;
calculating and storing an average of the time information read from channels other than the detected erroneous channel; and
displaying the stored average of the time information when a broadcasting signal of the erroneous channel is received.
